(19) United States
(12) Patent Application Publication
(10) Pub. No.: US 2021/0293312 A1
(43) Pub. Date: Sep. 23, 2021

(54) DOUBLE NUT STROKE ADJUSTMENT TRAVEL STOP

(71) Applicant: Goodrich Actuation Systems Limited, Solihull West Midlands (GB)

(72) Inventor: Andrew HAWKSWORTH, Moreton (GB)

(21) Appl. No.: 17/205,187

(22) Filed: Mar. 18, 2021

(30) Foreign Application Priority Data
Mar. 20, 2020 (EP) 20275060.0

(51) Int. Cl. F16H 25/20; F16H 25/24

(52) U.S. Cl. CPC F16H 25/2015; F16H 25/24

(57) ABSTRACT

A travel stop assembly for an actuator. The travel stop assembly includes a housing, a shaft provided along a longitudinal axis (A). The shaft has a first end and a second end. The travel stop assembly also includes a first nut and a second nut provided on the shaft, wherein there is provided a first gap (A_{g}) between the first nut and the second nut. The travel stop assembly also includes a second gap (S_{g}) provided between the second nut and the first end of the shaft, and means for adjusting the position of the first nut and the second nut such that the second gap (S_{g}) is maintained.

### FOREIGN PRIORITY

This application claims priority to European Patent Application No. 20275060.0 filed Mar. 20, 2020, the entire contents of which is incorporated herein by reference.

### TECHNICAL FIELD

The present disclosure relates to an over travel stop unit for actuator valves. In particular, the present disclosure relates to an assembly and a method of adjustment for an over travel stop unit.

### BACKGROUND

Actuators require accurate travel stop adjustments at ends of the stroke to obtain optimal performance and valve seat life. In normal conditions, an actuator system includes travel stops and components specific to that particular actuator system. For example, the length of the screw will be specific to the stroke requirement of that particular actuator system. There is, therefore, a need for providing an adjustable travel stop unit that can be retrofitted to a range of actuator systems.

### SUMMARY OF THE INVENTION

In one example, there is provided a travel stop assembly for an actuator. The travel stop assembly includes a housing, a shaft provided along a longitudinal axis. The shaft has a first end and a second end. The travel stop assembly also includes a first nut and a second nut provided on the shaft, wherein there is provided a first gap between the first nut and the second nut. The travel stop assembly also includes a second gap provided between the second nut and the first end of the shaft, and means for adjusting the position of the first nut and the second nut such that the second gap is maintained.

Preferably, the means for adjusting the position of the first nut and the second nut may further include a first rod and a second rod provided at an inner wall of the housing. The first nut may include a first hook and a second hook that are configured to engage the first rod and the second rod. Further, the second nut may include a first hook and a second hook that are configured to engage the first rod and the second rod.

The first rod and second rod may be parallel to the shaft, and the first rod may be opposite the second rod.

The travel stop assembly may further include a first end stop provided at the second end of the shaft, a second end stop provided on one side of the first nut, a third end stop provided at the first end of the shaft, and a fourth end stop provided on one side of the second nut. The second gap may be provided between the third end stop and the fourth end stop.

The second end stop may include at least one protrusion that extends radially away from the surface of the first nut along the longitudinal axis. The fourth end stop may also include at least one protrusion that extends radially away from the surface of the second nut along the longitudinal axis.

Preferably, the shaft is a threaded screw.

There is also provided an actuator assembly including the travel stop assembly as described above.

There is also provided a method of adjusting a resultant stroke gap of a travel stop unit, which includes providing a shaft along a longitudinal axis, the shaft having a first end and a second end, providing a first nut and a second nut on the shaft, providing a first gap between the first nut and the second nut, providing a second gap between the second nut and the first end of the shaft, and adjusting the position of the first nut and the second nut such that the second gap is maintained in a housing.

Preferably, adjusting the position of the first nut and the second nut may further include providing a first rod and a second rod at an inner wall of the housing, and engaging a first hook and a second hook of the first nut to the first rod and the second rod, and engaging a first hook and a second hook of the second nut to the first rod and the second rod. The first rod and second rod may be parallel to the shaft, and the first rod may be opposite the second rod.

The method may further include providing a first end stop at the second end of the shaft, providing a second end stop on one side of the first nut, providing a third end stop at the first end of the shaft, and providing a fourth end stop on one side of the second nut. The second gap may be provided between the third end stop and the fourth end stop.

Preferably, the second end stop may further comprise at least one protrusion that extends radially away from the surface of the first nut along the longitudinal axis, and the fourth end stop may further comprise at least one protrusion that extends radially away from the surface of the second nut along the longitudinal axis.

### BRIEF DESCRIPTION OF THE DRAWINGS

FIG. 1 shows an example of an assembly for travel stop adjustment.

FIG. 2 shows an example of the nuts employed in the assembly of FIG. 1.

FIG. 3 shows a further example of a nut that may be employed in the assembly of FIG. 1.

### DETAILED DESCRIPTION

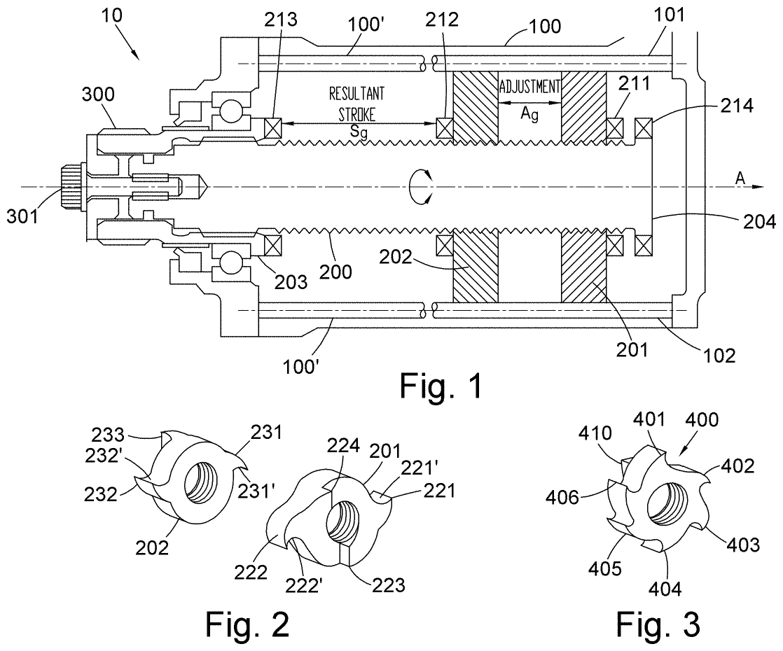

Referring to FIG. 1, there is shown an example of an assembly 10. The assembly 10 may also be known as an over travel stop unit. The assembly 10 may include a housing 100 to house various components that allow for adjustment of the travel stop. As an example shown in FIG. 1, the assembly 10 may have a longitudinal axis A running through the centre of the assembly 10 and the housing 100 may be provided about this longitudinal axis A. As shown in FIG. 1, there may be provided a shaft, for example, a threaded screw 200 along the longitudinal axis A of the assembly 10. A first nut 201 and a second nut 202 can be received on the threaded screw 200. An adjustment gap A_{g} may be formed between the first nut 201 and the second nut 202. This may be done manually by an engineer before incorporating the components for the assembly 10 in the housing 100.

A first rod 101 may be provided at an inner wall 100′ of the housing 100. The first rod 101 runs parallel to the threaded screw 200. A second rod 102 may be provided at the inner wall 100′ of the housing 100, opposite the first rod 101. In the examples shown in FIG. 1, the first rod 101 and the second rod 102 are cylindrical. Of course, it is envisaged that other geometries could be used as well to allow the first nut 201 and second nut 202 to engage with the first rod 101 and second rod 102, as described in more detail below.

As shown in FIG. 1, the threaded screw 200 has a first end 203 and a second end 204. Provided at the second end 204 of the threaded screw 200 is a first end stop 214. Provided on one side of the first nut 201 is a second end stop 211 that faces the first end stop 214 (i.e., the second end stop 211 is to the right hand side of the first nut 201). Provided at the first end 203 of the threaded screw 200 is a third end stop 213. Provided on one side of the second nut 202 is a fourth end stop 212 that faces the third end stop 213 (i.e., the fourth end stop 212 is provided on the left hand side of the second nut 202). The gap between the third end stop 213 and the fourth end stop 212 is designated by the reference S_{g} and refers to the resultant stroke gap. Before the housing 100 is applied to an actuator assembly (not shown), a user can adjust the resultant stroke gap S_{g} by placing the first nut 201 and second nut 202 at the desired positions on the threaded screw 200. The user can then engage the threaded screw 200 in the housing 100. An axial screw 301 is applied to the threaded screw 200 to maintain the position of the threaded screw 200 in the housing 100. There is also provided an adjustment means 300, which may be in the form of an exposed outer spline of the threaded screw 200. This is described in more detail below.

Referring to FIG. 2, the first nut 201 and the second nut 202 are shown. As can be seen in FIG. 2, the first nut 201 may include a first hook 221 that extends radially from the overall surface of the first nut 201. The first nut 201 may also include a second hook 222 that also extends radially from the overall surface of the first nut 201. The first hook 221 of the first nut 201, therefore, provides a first hook surface 221′ that can interact with one of the first rod 101 or the second rod 102 (as shown in FIG. 1), in use. The first hook surface 221′ is perpendicular to the overall surface of the first nut 201 and is configured to receive one of the first rod 101 or the second rod 102 (e.g. it includes a recess (not shown) that is sized and shaped to receive either the first rod 101 or the second rod 102). The second hook 222 also may provide a second hook surface 222′ that can interact with one of the first rod 101 or the second rod 102, in use. The second hook surface 222′ is perpendicular to the overall surface of the first nut 201 and is configured to receive one of the first rod 101 or the second rod 102 (e.g. it includes a recess (not shown) that is sized and shaped to receive either the first rod 101 or the second rod 102).

As also shown in FIG. 2, the first nut 201 may have a first protrusion 223 and a second protrusion 224 that extend radially from the surface of the first nut 201 along the longitudinal axis. The first protrusion 223 and second protrusion 224 may therefore act as the second end stop 211 shown in FIG. 1.

As can also be seen in FIG. 2, the second nut 202 may include a first hook 231 that extends radially from the surface of the second nut 202. The second nut 202 may also include a second hook 232 that also extends radially from the surface of the second nut 202. The first hook 231 of the second nut 202, therefore, provides a first hook surface 231′ that can interact with one of the first rod 101 or the second rod 102 (as shown in FIG. 1), in use. The first hook surface 231′ is perpendicular to the overall surface of the second nut 202 and is configured to receive one of the first rod 101 or the second rod 102 (e.g. it includes a recess (not shown) that is sized and shaped to receive either the first rod 101 or the second rod 102). The second hook 232 also may provide a second hook surface 232′ that can interact with one of the first rod 101 or the second rod 102, in use. The second hook surface 232′ is perpendicular to the overall surface of the second nut 202 and is configured to receive one of the first rod 101 or the second rod 102 (e.g. it includes a recess (not shown) that is sized and shaped to receive either the first rod 101 or the second rod 102).

As also shown in FIG. 2, the second nut 202 may have a first protrusion 233 and a second protrusion (not shown) that extend radially from the surface of the first nut 201 along the longitudinal axis. The first protrusion 233 and second protrusion (not shown) may therefore act as the fourth end stop 212 shown in FIG. 1.

As shown in FIG. 2, the first nut 201 and the second nut 202 are arranged such that protrusions 223, 224 and 233 are facing away from each other. In other words, when the first nut 201 and the second nut 202 are arranged on the threaded screw 200, they are equal parts inversed along the longitudinal axis.

Referring now to both FIGS. 1 and 2, the first nut 201 and second nut 202 may be introduced on to the threaded screw 200 by the user. When the travel stop unit, or assembly 10, is to be fitted to an actuator system, the user may first determine and set the position of the first nut 201 and the second nut 202 to result in the adjustment gap A_{g} (i.e., the space between the first nut 201 and the second nut 202). Once the first nut 201 and the second nut 202 have been placed in the assembly 10, the user may then set the resultant stroke gap, S_{g}, by turning the threaded screw 200 with the adjustment means 300. As the threaded screw 200 turns, the first hook surface 221′ of the first nut 201 may contact one of either the first rod 101 or the second rod 102. The second hook surface 222′ of the first nut 201 may then contact the other of either the first rod 101 or the second rod 102 (i.e., the rod that is not being contacted by the first hook surface 221′ of the first nut 201). Similarly, as the threaded screw 200 turns, the first hook surface 231′ of the second nut 202 may also contact either one of the first rod 101 or the second rod 102. The second hook surface 232′ of the second nut 202 may then contact the other of either the first rod 101 or the second rod 102 (i.e., the rod that is not being contacted by the first hook surface 231′ of the second nut 202).

When the first hook surfaces 221′ and 231′, and the second hook surfaces 222′ and 232′, of the first and second nut 201 and 202 are engaged with the first rod 101 and the second rod 102, the first nut 201 and the second nut 202 are then set in position, which results in the resultant stroke gap S_{g}.

FIG. 3 shows an alternative nut 400 that could replace the first nut 201 and second nut 202 described above. In the example shown in FIG. 3, there is provided a nut 400 (which could form the first nut 201 and the second nut 202 described above) that may include a first hook 401, a second hook 402, a third hook 403, a fourth hook 404, a fifth hook 405 and a sixth hook 406. In this way, the user may have smaller turns to engage the first rod 101 and the second rod 102, which allows for a more accurate adjustment of the resultant stroke gap S_{g}. It is appreciated that the nut 400, in this example, includes six hooks, but that any number of hooks of more than two could replace the hooks described in relation to the first nut 201 and second nut 202 in FIG. 2. There may also be provided a first protrusion 410 on the alternative nut 400 that acts as an end stop in relation to the protrusions described with reference to FIG. 2.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims.

1. A travel stop assembly for an actuator, comprising:
a housing;
a shaft provided along a longitudinal axis (A), the shaft having a first end and a second end;
a first nut and a second nut provided on the shaft, wherein there is provided a first gap (A_{g}) between the first nut and the second nut;
a second gap (S_{g}) provided between the second nut and the first end of the shaft;
means for adjusting the position of the first nut and the second nut such that the second gap (S_{g}) is maintained.

2. The travel stop assembly of claim 1, wherein the means for adjusting the position of the first nut and the second nut further comprises:
a first rod and a second rod provided at an inner wall of the housing;
wherein the first nut includes a first hook and a second hook that are configured to engage the first rod and the second rod; and
wherein the second nut includes a first hook and a second hook that are configured to engage the first rod and the second rod.

3. The travel stop assembly of claim 2, wherein the first rod and second rod are parallel the shaft, and wherein the first rod is opposite the second rod.

4. The travel stop assembly of claim 1, further comprising:
a first end stop provided at the second end of the shaft;
a second end stop provided on one side of the first nut;
a third end stop provided at the first end of the shaft; and
a fourth end stop provided on one side of the second nut.

5. The travel stop assembly of claim 4, wherein the second gap (S_{g}) is provided between the third end stop and the fourth end stop.

6. The travel stop assembly of claim 4, wherein the second end stop comprises at least one protrusion that extends radially away from the surface of the first nut along the longitudinal axis.

7. The travel stop assembly of claim 4, wherein the fourth end stop comprises at least one protrusion that extends radially away from the surface of the second nut along the longitudinal axis.

8. The travel stop assembly of claim 1, wherein the shaft is a threaded screw.

9. An actuator assembly including:
a travel stop assembly as claimed in claim 1.

10. A method of adjusting a resultant stroke gap of a travel stop unit, the method comprising:
providing a shaft along a longitudinal axis (A), the shaft having a first end and a second end;
providing a first nut and a second nut on the shaft;
providing a first gap (A_{g}) between the first nut and the second nut;
providing a second gap (S_{g}) between the second nut and the first end of the shaft; and
adjusting the position of the first nut and the second nut such that the second gap (S_{g}) is maintained in a housing.

11. The method of claim 10, wherein adjusting the position of the first nut and the second nut further comprises:
providing a first rod and a second rod at an inner wall of the housing, and engaging a first hook and a second hook of the first nut to the first rod and the second rod; and
engaging a first hook and a second hook of the second nut to the first rod and the second rod.

12. The method of claim 11, wherein the first rod and second rod are parallel the shaft, and wherein the first rod is opposite the second rod.

13. The method of claim 10, the method further comprising:
providing a first end stop t the second end of the shaft;
providing a second end stop on one side of the first nut;
providing a third end stop at the first end of the shaft; and
providing a fourth end stop on one side of the second nut.

14. The method of claim 13, wherein the second gap (S_{g}) is provided between the third end stop and the fourth end stop.

15. The method of claim 14, wherein the second end stop comprises at least one protrusion that extends radially away from the surface of the first nut along the longitudinal axis, and wherein the fourth end stop comprises at least one protrusion that extends radially away from the surface of the second nut along the longitudinal axis.

16. The method of claim 13, wherein the second end stop comprises at least one protrusion that extends radially away from the surface of the first nut along the longitudinal axis, and wherein the fourth end stop comprises at least one protrusion that extends radially away from the surface of the second nut along the longitudinal axis.
